(19) United States
(12) Patent Application Publication
(10) Pub. No.: US 2013/0152694 A1
(43) Pub. Date: Jun. 20, 2013

(54) SENSOR WITH VACUUM CAVITY AND METHOD OF FABRICATION

(71) Applicants: Ilkka Urvas, Espoo (FI); Andrei Jurievich Pavlov, Naantali (FI); Yelena Vasiljevna Pavlova, Naantali (FI)

(72) Inventors: Ilkka Urvas, Espoo (FI); Andrei Jurievich Pavlov, Naantali (FI); Yelena Vasiljevna Pavlova, Naantali (FI)

(21) Appl. No.: 13/666,775

(22) Filed: Nov. 1, 2012

Related U.S. Application Data
(60) Provisional application No. 61/554,212, filed on Nov. 1, 2011.

(51) Int. Cl. G01L 9/00

(52) U.S. Cl. CPC G01L 9/0048
USPC 73/724

(57) ABSTRACT

A MEMS pressure sensor device comprises a sensor element positioned on top of a carrier and a cavity. The sensor element hermetically seals the cavity. An electrode is coupled to the cavity that forms a pressure transducer together with the sensor element. The cavity is created by a density changing material.

### CROSS-REFERENCE TO RELATED APPLICATIONS

This application claims priority from U.S. patent application No. 61/554,212, filed Nov. 1, 2011, and is related to U.S. patent application Ser. No. 12/370,882 titled “Resonant MEMS device that detects photons, particles and small forces,” Ser. No. 12/961,079 titled “Electromechanical systems, waveguides and methods of production,” 61/388,481 titled “Method for fabrication of deep vacuum gap cavities inside materials,” 61/417537 titled “Metal and semiconductor nanotubes and hollow wires and method for their fabrication”, all of which are hereby incorporated by reference in their entirety.

### TECHNICAL FIELD

The present invention is in the technical field of integrated thin film devices. More particularly, the present invention is in the technical field of microelectromechanical (MEMS) devices.

### BACKGROUND OF THE INVENTION

Pressure sensing devices are known. Examples of such devices are described in U.S. Pat. No. 3,858,097 titled “PRESSURE-SENSING CAPACITOR”, U.S. Pat. No. 4,542,436 titled “Linearized capacitive pressure transducer”, U.S. Pat. No. 6,564,643 titled “Capacitive pressure sensor”, U.S. Pat. No. 5,186,054 titled “Capacitive pressure sensor”, U.S. Pat. No. 5,499,535 titled “Pressure sensor and temperature sensor”, U.S. Pat. No. 7,667,996 titled “Nano-vacuum-tubes and their application in storage devices”, “Novel Designs for Application Specific MEMS Pressure Sensors”, Giulio Fragiacomo et al, Sensors 2010, 10 and “TINY (0.72 mm2) PRESSURE SENSOR INTEGRATING MEMS AND CMOS LSI WITH BACK-END-OF-LINE MEMS PLATFORM”, T. Fujimori, H. Takano, S. Machida, and Y. Goto, Transducers 2009, Denver, Colo., USA, Jun. 21-25, 2009.

Conventional electronic devices, such as microelectromachanical (MEMS) absolute pressure sensors, have a limited performance and/or complicated manufacturing process with the existing technologies. Systems that are using discrete MEMS transducer devices are typically using an additional CMOS integrated circuit to process the transducer signal into a pressure level data that can be used by the data processing units of the system, such as microcontrollers. Thus the system requires two separate semiconductor devices that have been manufactured using different technologies, typically with separate and dedicated equipment. In addition, the system requires a complicated package for two chips and additional input and output interfaces on both chips to transfer the signals between them.

Alternatively, a dedicated process that combines for example CMOS and MEMS processing steps may be used to integrated the pressure transducer and the electronics on the same chip. In this case, the system is simplified, as the transducer part and the electronics can be connected using the chip interconnections, and the packaging is simplified as only one chip needs to be included in the package. However, the process is more complicated and expensive than a standard CMOS process due to the necessary MEMS processing steps. Typically, some kind of a sacrificial layer is deposited during the process and later removed in order to form a cavity, so that a pressure sensing membrane can be formed. The etching process is complicated and results in limited accuracy in the roughness of the cavity surfaces, in addition the minimum height of the cavity is limited with this method. As this processing step is not compatible with standard CMOS technology, it requires a dedicated foundry which complicates the second sourcing of such technologies and limits the availability of this kind of solutions especially for fabless semiconductor companies.

The present MEMS pressure transducers are typically based on piezoresistive or capacitive sensing principle. In both cases, the resulting transducer has a moving membrane that is moving based on the pressure difference between the opposite surfaces of the membrane. In piezoresistive sensing, the membrane is mechanically connected to resistors that change their resistance value based on the change in stress that is cause by the movement of the membrane. In capacitive sensing, the membrane forms a second electrode of a capacitor, and the capacitance value changes according to the movement of the membrane. The piezoresistive sensors have relatively large power consumption, strong temperature dependency and a limited accuracy due to the resistor based thermal noise. The capacitive sensors have relatively low power consumption and a very low noise floor level, but require more complex measurement electronics and are sensitive to parasitic capacitance. In the capacitive sensors, the sensitivity is approximately inversely proportional to the distance between the electrodes of the capacitor, so it is beneficial to reduce the height of the cavity between the electrodes.

### SUMMARY OF THE INVENTION

Briefly according to the present invention, a MEMS pressure sensing device has cavities with vertical height in nanometer scale that are manufactured with conventional thin film processing equipment such as those used in a CMOS foundry. The present invention enables the design of low cost, high volume devices with vacuum cavities within the chip. A typical device has a membrane that functions as the sensing element of the transducer. The membrane is formed by creating a vacuum cavity below the surface layer of the carrier, e.g. a CMOS chip. The transducer generates an output electrical signal that is proportional to the pressure affecting the sensing element. The sensing of the transducer can be based on either a change in capacitance or change in conductivity associated with electron tunneling current in the transducer, or the combination of both. In order to provide an output signal the device may require an input signal that is typically a DC, AC or modulated voltage or current.

The present invention provides means to produce a transducer where the moving membrane is separated from the bottom of the cavity by a very short distance in the order of nanometers to hundreds of nanometers. If the transducer is using capacitive sensing, this short distance enables a very high capacitance density and high change in capacitance for a given displacement of the sensor element, which results in improved sensitivity, and reduced area requirements for a given capacitance value. The possibility of using separation distance in the order of nanometers enables transducer structures where electron tunneling occurs between electrodes that are separated by the vacuum cavity. In this case a DC input signal can be used to generate a DC output signal that is very sensitive to the movement of the membrane. The use of DC signals simplifies the requirements of measurement electronics. In addition to the capacitive and electron tunneling based sensing it is also possible to use piezoresistive sensing; here the main benefit is related to the simplified process technology in making the cavity, since the small height of the cavity does not bring additional benefits to the sensing mechanism.

### BRIEF DESCRIPTION OF THE DRAWINGS

FIG. 1 is a cross-section view of a pressure sensor device with a sensor element, cavity and carrier;

FIG. 2 is a top view of a pressure sensor device with a sensor element, cavity and carrier;

FIG. 3 is a pressure sensor device with essentially the same pressure level within the cavity and the ambient medium;

FIG. 4 is a pressure sensor device with some pressure difference between the cavity and the ambient medium so that the sensor element is deforming and freely moving;

FIG. 5 is a pressure sensor device with pressure difference between the cavity and the ambient medium so that the sensor element is deforming enough to touch the carrier in the middle. touching point;

FIG. 6 is a pressure sensor device with pressure difference between the cavity and the ambient medium so that the sensor element is deforming enough to cause an increased area to touch the carrier in the middle;

FIG. 7 is a pressure sensor device with pressure difference between the cavity and the ambient medium so that the sensor element is deforming enough to cause a large area to touch the carrier in the middle;

FIG. 8 is a cross-section of a pressure sensor device with a sensor element, electrode, carrier and cavity;

FIG. 9 is a cross-section of a pressure sensor device with a deformed sensor element, electrode, carrier and cavity;

FIG. 10 is a cross-section of a pressure sensor device with a deformed sensor element touching the electrode, electrode, carrier and cavity;

FIG. 11 is a cross-section of a pressure sensor device with a sensor element, embedded electrode, carrier and cavity;

FIG. 12 is a cross-section of a pressure sensor device with a deformed sensor element, embedded electrode, carrier and cavity;

FIG. 13 is a cross-section of a pressure sensor device with a deformed sensor element touching the carrier, embedded electrode, carrier and cavity;

FIG. 14 is a cross-section of a pressure sensor device with a top layer having embedded top electrodes, cavity, bottom electrode and carrier;

FIG. 15 is a cross-section of a pressure sensor device with a deformed top layer having embedded top electrodes, cavity, bottom electrode and carrier;

FIG. 16 is a close up of the cavity area in FIG. 15;

FIG. 17 is a cross-section of a pressure sensor device with a deformed top layer having embedded top electrodes, cavity, bottom electrode and carrier with external voltage supplies and current meters;

FIG. 18 is a cross-section of a pressure sensor device with a top layer having embedded top electrodes, cavity, bottom electrode and carrier with external voltage supplies and current meter;

FIG. 19 is a top view of a pressure sensor device of FIG. 18 with a top layer having embedded top electrodes, cavity, bottom electrode and carrier;

FIG. 20 is a cross-section of a pressure sensor device with a deformed top layer having embedded top electrodes, cavity, bottom electrode and carrier with external voltage supplies and current meter;

FIG. 21 is a cross-section of a pressure sensor device with a top layer with suspended needle electrode, cavity, bottom electrode and carrier;

FIG. 22 is a cross section of a pressure sensor device and a reference device;

FIG. 23-FIG. 25, FIG. 27-FIG. 31, FIG. 33 and FIG. 34 are cross-section views of processing steps for making a pressure sensor device.

FIG. 26 and FIG. 32 are top views of processing steps for making a pressure sensor

### DETAILED DESCRIPTION OF THE INVENTION

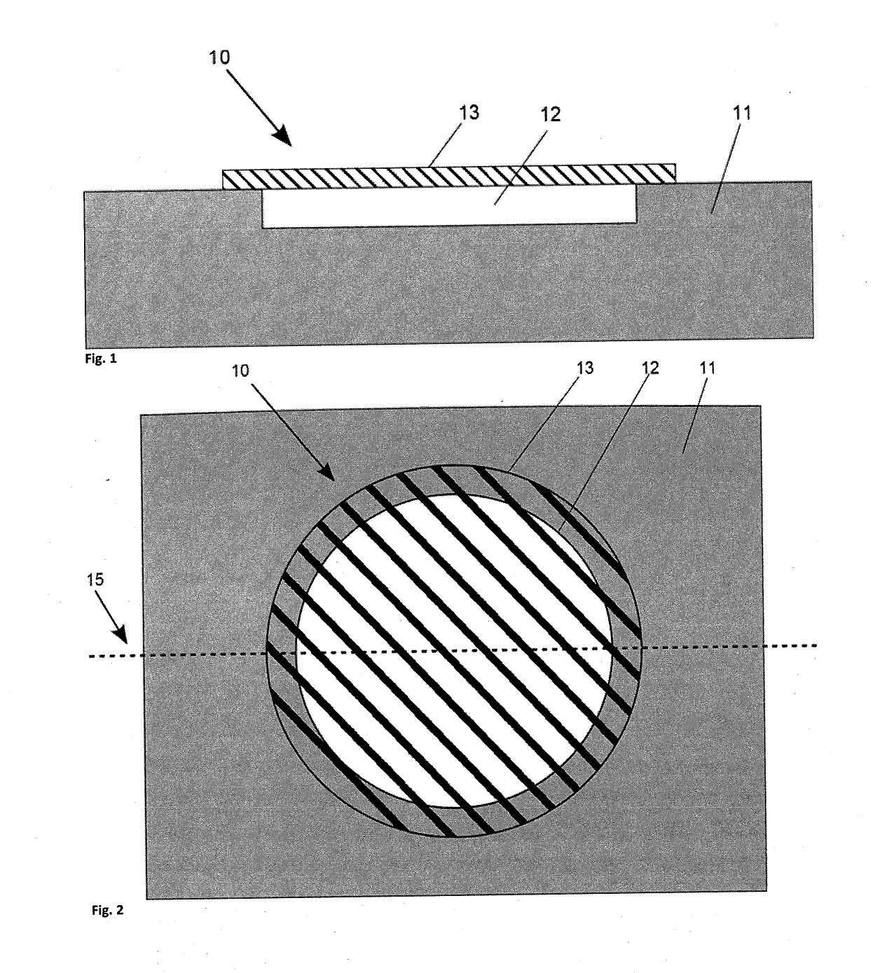

Referring now to the first embodiment of the invention in more detail, in FIG. 1 and FIG. 2 there is shown a pressure sensor device 10 having a sensor element 13 that is on the top of the carrier 11 and the cavity 12. The sensor element 13 is covering the cavity 12 area so that it is hermetically sealed. The location of cross-section that is used for FIG. 1 is shown by the dashed line 15 in FIG. 2 that represents the top view of the device. Pressure sensor device 10 is used to describe the mechanical actuation of the sensor element 13, for this reason the other parts of the transducer are omitted.

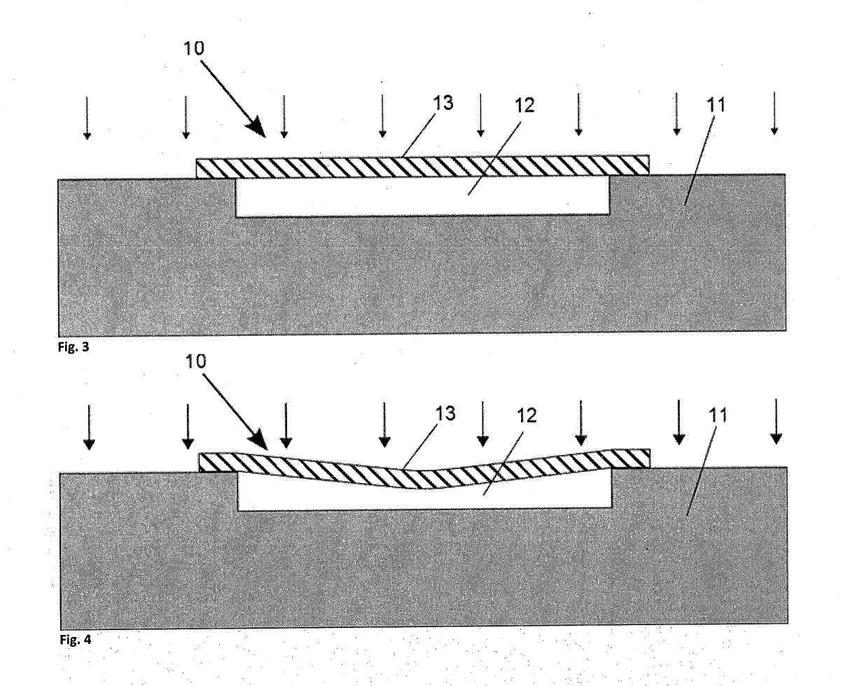

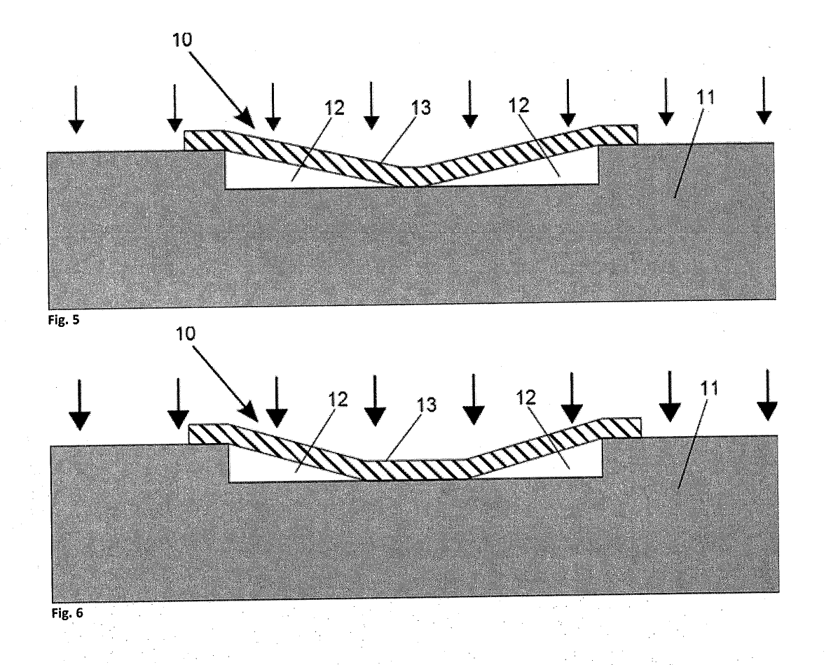

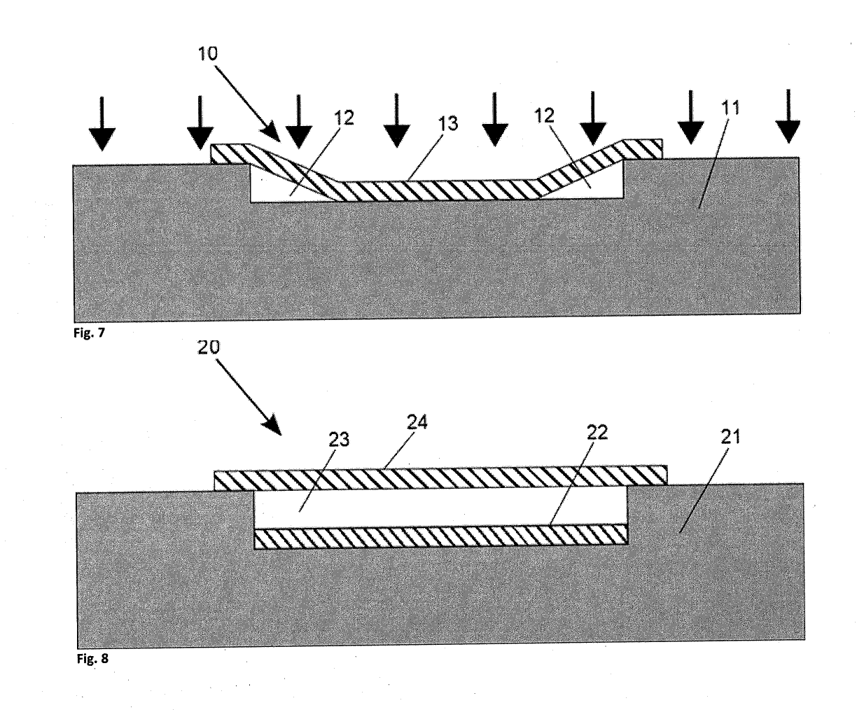

The deformation of the sensor element 13 of pressure sensor device 10 is shown as a sequence in FIG. 3 to FIG. 7. In the figures eight down pointing arrows are used to depict the ambient pressure. In FIG. 3 the ambient pressure is very low, i.e. essentially the same as in the cavity 12. As a result the sensor element is not deformed by a pressure difference between the cavity and the ambient medium of the device. In FIG. 4 the ambient pressure is greater than the pressure in the cavity 12, resulting in a deformation of the sensor element 13 towards the cavity 12. The sensor element 13 is freely moving as it is not touching the carrier 11 from parts other than the edge of the sensor element 13. In FIG. 5 the ambient pressure is increased to the extent that the sensor element 13 is touching the carrier 11 also at a point that is in the center area of the sensor element 13. In FIG. 6 the ambient pressure is higher than in FIG. 5, which results in stronger deformation of the sensor element 13 and a larger area in the center of the sensor element 13 touching the carrier 11. When the sensor element 13 is in the described touching mode it takes a larger relative change in pressure to cause a given deformation in the sensor element 13 compared to free moving mode. In FIG. 7 the ambient pressure is increased further so that the majority of the sensor element 13 is touching the carrier 11. Depending on the height of the cavity it may be possible that the device can withstand so much pressure that practically the whole bottom surface of the sensor element 13 is touching the carrier 11.

Depending on the usage scenario it may be desirable to use a pressure sensor in the free moving mode, in the touching mode or in the combination of them. In the free moving mode the pressure sensor may have more linear characteristics as opposed to the more nonlinear operation in the touching mode. The operating point where a sensor element goes from free moving to touching, such as shown in FIG. 5, may be used as a reference point for example for the calibration of the sensor. The reference point may be also based on the point where the sensor element 13 is not physically touching the carrier 11, but is close enough to cause a significant tunneling current in the transducer.

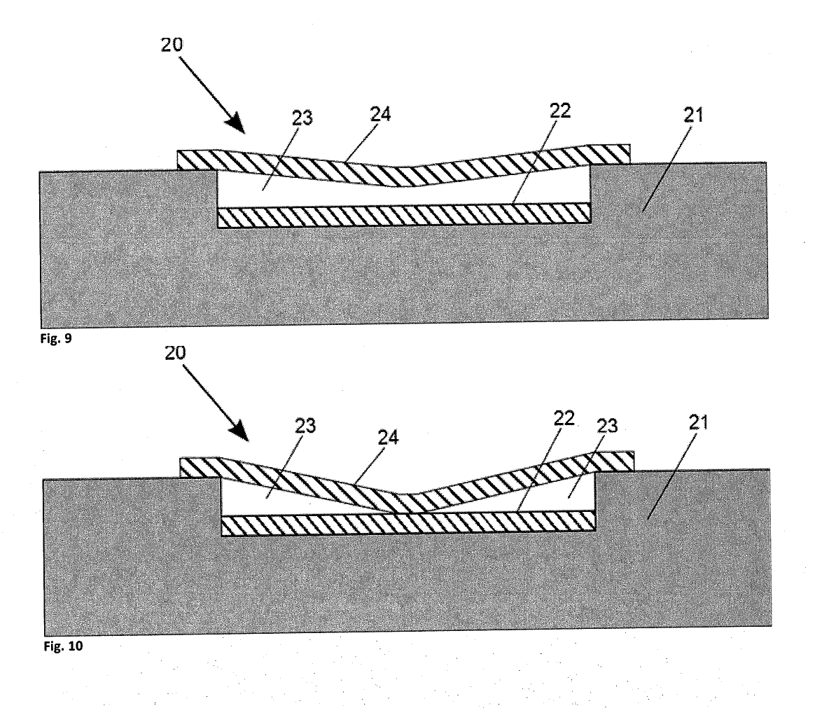

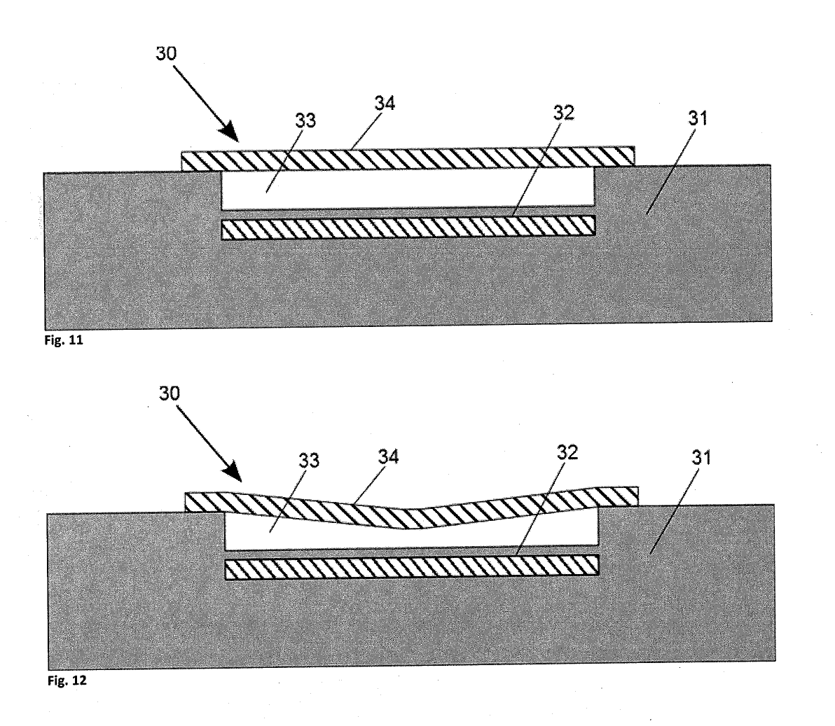

Referring now to the second embodiment of the invention, in FIG. 8, FIG. 9 and FIG. 10 there is shown a pressure sensor device 20 having a sensor element 24 that is on the top of the carrier 21 and the cavity 23. The sensor element 24 is covering the cavity 23 area so that it is hermetically sealed. The bottom of the cavity 23 is covered by an electrode 22 that forms a capacitor i.e. the transducer together with the sensor element 24. In FIG. 8 the ambient pressure is minimal, therefore the sensor element 24 is not deformed and the capacitance of the pressure sensor device 20 is at its minimum. In FIG. 9 the ambient pressure is increased and as a consequence the sensor element 24 is deformed increasing the capacitance of the device. In FIG. 10 the ambient pressure is high enough to bring the sensor element 24 into a physical contact with the electrode 22. This can be detected as a short circuit of the transducer, which can be used to define the touching point of the pressure sensor device 20.

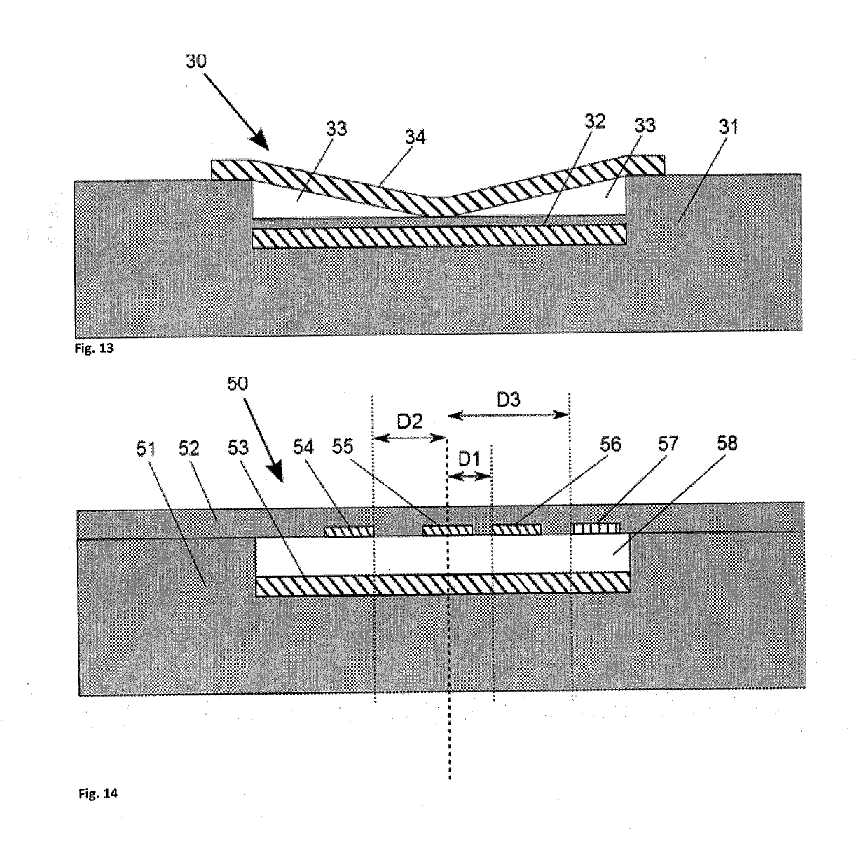

Referring now to the third embodiment of the invention, in FIG. 11, FIG. 12 and FIG. 13 there is shown a pressure sensor device 30 having a sensor element 34 that is on the top of the carrier 31 and the cavity 33. The sensor element 34 is covering the cavity 33 area so that it is hermetically sealed. Below the cavity 33 embedded in the carrier 31 there is the electrode 32 that forms a capacitor i.e. the transducer together with the sensor element 34. In FIG. 11 the ambient pressure is minimal, therefore the sensor element 34 is not deformed and the capacitance of the pressure sensor device 30 is at its minimum. In FIG. 12 the ambient pressure is increased and as a consequence the sensor element 34 is deformed increasing the capacitance of the device. In FIG. 13 the ambient pressure is high enough to bring the center of the sensor element 34 into a physical contact with the carrier 31. However, as this part of the carrier 31 is made of an insulating material, there will not be short circuit between the sensor element 34 and the electrode 32. The change of capacitance in the pressure sensor device 30 can be relatively higher in the touching mode as the dielectric constant of the carrier 31 material between the electrodes is higher than the dielectric constant of the cavity 33. Whereas the pressure sensor device 20 is mainly suitable to be used in the free moving mode, the pressure sensor device 30 is suitable also for operation in the touching mode.

The shown example consists of a single capacitor acting a s a transducer, however there can be a plurality of capacitors used for sensing within a single pressure sensor device. Different asymmetrical geometries can be designed for the capacitor electrodes so that each gives a different response as a function of the ambient pressure that is being measured. This can be used to optimize e.g. the linearity of the pressure sensor output signals in various operating ranges.

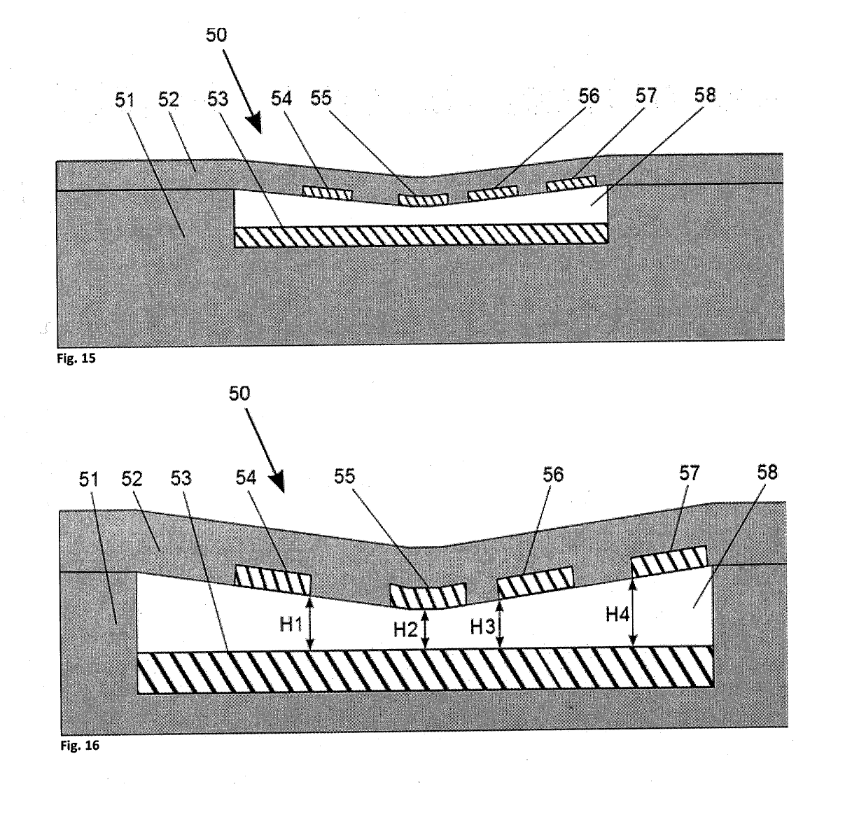

Referring now to the fourth embodiment of the invention in FIG. 14, FIG. 15, FIG. 16 and FIG. 17, there is shown a pressure sensor device 50 having a surface layer 52 that is on the top of the carrier 51 and the cavity 58 that is sealed hermetically. The surface layer 52 has embedded top electrodes 54, 55, 56 and 57 above the cavity 58. The bottom of the cavity 58 is covered by the bottom electrode 53. As shown in FIG. 14, the electrodes may be located at different distances from the center of the cavity 58. In the given case the electrode 55 is in the center of the cavity, electrode 56 is separated by the distance D1 from the center, electrode 54 is separated by D2 and electrode 57 is separated by D3. FIG. 15 shows the pressure sensor device 50 when the ambient pressure is high enough to deform the part of the surface layer 52 that is above the cavity 58 so that the pressure sensor device 50 is in free moving mode. The sensor element consists of the moving part of the surface layer 52 above the cavity 58 together with the top electrodes 54, 55, 56 and 57. FIG. 16 has a close-up of the pressure sensor device 50, which shows that the minimum height H1-H4 between any top electrode 54-57 and the bottom electrode 53 depending from the distance of the electrode 54-57 from the center of the cavity 58 when the sensor element is deformed by e.g. external pressure. The electrode 55 has zero distance from the center of the cavity 58 and as the result the minimum height H2 is less than for any other of the electrodes. The electrode 56 has the second smallest distance D1 and correspondingly has a second smallest height H3. The electrode 54 follows in order for both distance D2 and height H1, and finally electrode 57 has the largest distance and correspondingly the largest height H4.

Different distances can be used to create different types of tunneling current. In the middle channel, H2, there can be a multichannel tunneling whereas on others, H1 or H4, there can be tunneling of single electrons. The different tunneling regimes can be controlled by different voltages applied to the different electrodes.

In special conditions, like in the flow of highly energetic particles including elementary particles, protons etc., the electrical current can be correlated with other charged carriers, for example, protons.

The pressure sensor device 50 is designed to have a very small height for the cavity 58, so that the electrodes 54-57 can conduct to the bottom electrode 53 by electron tunneling when the height H1-H4 is in the rough order of magnitude of 1 nm. This height may vary significantly as it is dependent on the materials, geometries and electric field strength between the electrodes 54 -57 and the bottom electrode 53, and the tunneling current varies as a function of heights H1-H4. Each electrode 54-57 can have a dedicated bias voltage V1, V2, V3 and V4 as depicted in FIG. 17. The bias voltages can be used to bias the pressure sensor device 50 dynamically after manufacturing to give optimal tunneling currents in desired pressure ranges based on the ambient operating conditions and geometries of the device.

Variations in the distances between the top electrodes and the bottom electrode can be correlated with the variations of effective band gap energy, associated with each pair of electrodes. Change in the effective band gap energy due to change in the pressure can be also used for the measurement of the pressure.

The number of top electrodes can be arbitrary from one to many; four elements have been selected here for demonstration purposes only. The top electrodes may be embedded inside the surface layer 52 so that they do not form direct contact with the bottom electrode under any conditions. Instead of a single bottom electrode 53 the device may have any number of bottom electrodes that would be typically coupled with one or more of the top electrodes. The bottom electrodes may be embedded i.e. contain an insulating layer on top of them to avoid direct contact with the top electrodes.

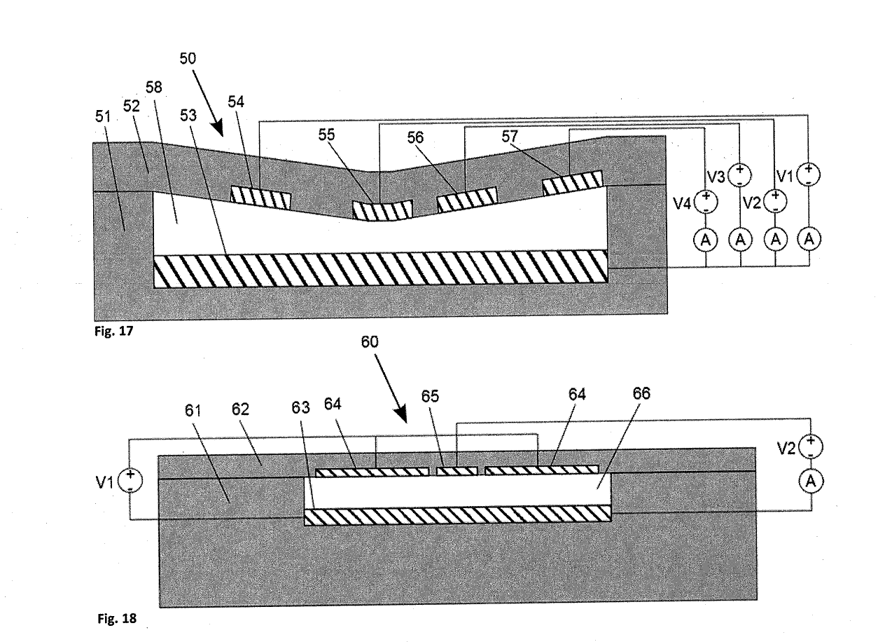

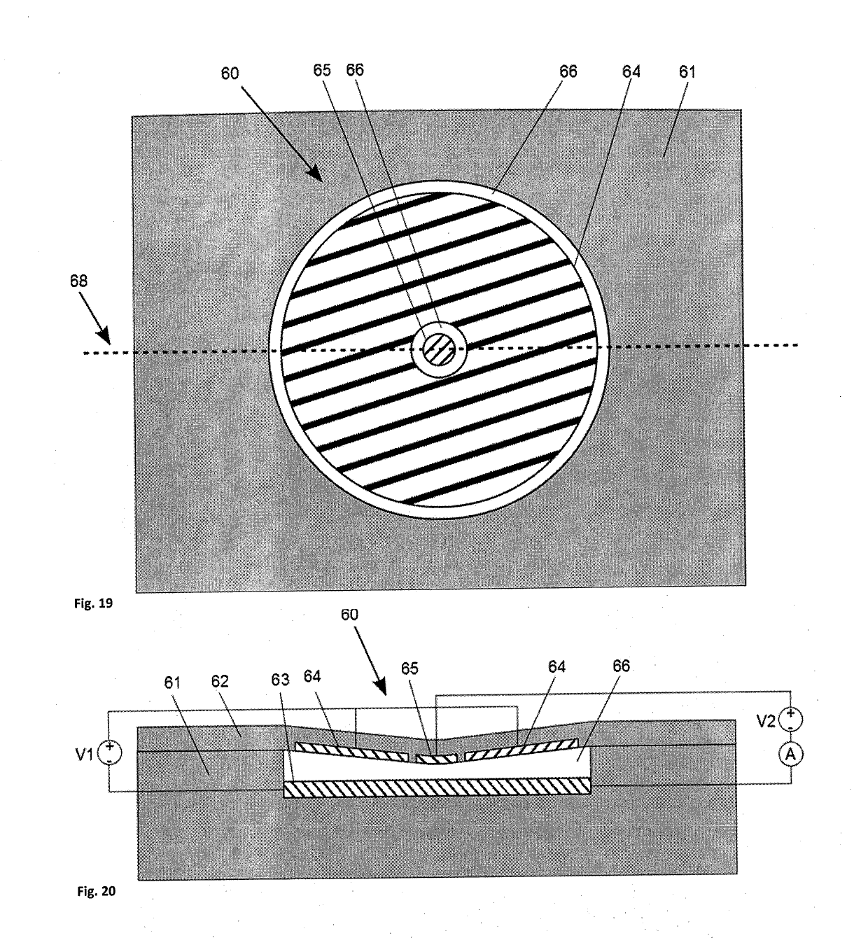

Referring now to the fifth embodiment of the invention in FIG. 18, FIG. 19 and FIG. 20, there is shown a pressure sensor device 60 having a surface layer 62 that is on the top of the carrier 61 and the cavity 66 that is sealed hermetically. The surface layer 62 has embedded top electrodes 64 and 65 above the cavity 66. The bottom of the cavity 66 is covered by the bottom electrode 63. FIG. 19 shows a top view of the pressure sensor device 60 without the surface layer 62 and the bottom electrode 63 to demonstrate a possible geometry for the top electrodes 64 and 65. The top electrode 64 has much larger area than the top electrode 65 and is therefore suitable for capacitive measurement and/or actuation of the device, whereas the centrally located top electrode 65 is more sensitive to the deformation of the surface layer 62 and therefore suitable for detecting the deformation by sensing the electron tunneling current between the top electrode 65 and bottom electrode 63. The cross section views of the device have been taken from the location of the line 68.

FIG. 18 shows a possible configuration of the pressure sensor device 60 with external bias and measurement circuitry. A dedicated bias voltage V1 can be applied between the top electrode 64 and the bottom electrode 63 for actuation. This will result in an electrostatic force between the top electrode 64 and bottom electrode 63. The electrostatic force can be used to deform the surface layer 62 above the cavity 66 for example to calibrate the pressure sensor device 60, tune it to a certain operating point or compensate for the ambient operating conditions. Another possibility as shown in FIG. 20 is to apply a compensated bias voltage V1 such that the surface layer 62 is deformed to give a desired tunneling current with a bias voltage V2 between the top electrode 65 and bottom electrode 63. A compensation circuit monitoring the tunneling current is used to control the bias voltage V1 so that the tunneling current is kept constant when the ambient pressure is changing, in other words the effect of the electrostatic force and ambient pressure on the pressure sensor device 60 is kept constant. In this setting the bias voltage V1 will vary as a function of ambient pressure and can therefore be used as the output signal of the pressure sensor device 60.

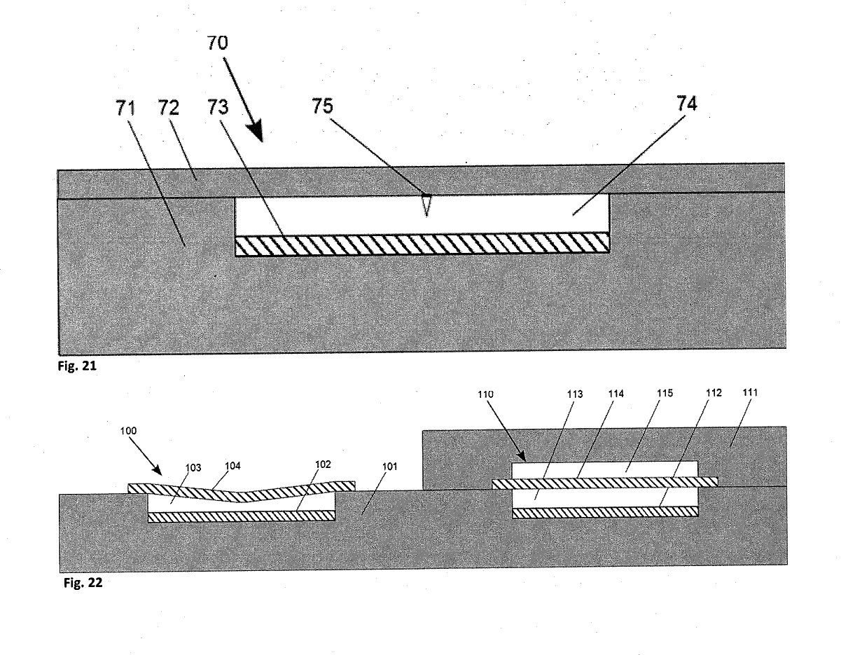

Referring now to the sixth embodiment of the invention in FIG. 21, there is shown a pressure sensor device 70 having a surface layer 72 that is on top of the carrier 71 and the cavity 74 that is sealed hermetically. The surface layer 72 has the needle electrode 75 suspended so that it forms a pair with the bottom electrode 73. The needle electrode 75 is wider at the top and narrowing down towards the extremely sharp tip that is closest to the bottom electrode 73. Applying a voltage difference between the needle electrode 75 and the bottom electrode 73 will create an electrical field that is strongly concentrated in the vicinity of the tip of the needle electrode 75. As a result an electron tunneling path will be generated if the voltage difference is sufficient providing means for measuring the deformation of the surface layer 72 above the cavity 74. Due to the small area of the tip of the needle electrode 75 the electrostatic force between the needle electrode 75 and the bottom electrode 73 will be relatively small, so that it does not impact significantly the deformation of the surface layer 72 area that is above the cavity 74. In this embodiment of the invention the height of the cavity 74 needs to be higher compared to the earlier embodiments in order to have enough space for the needle electrode 75.

Referring now to the seventh embodiment of the invention in FIG. 22, there is shown a pressure sensor device 100 having a sensor element 104 that is on the top of the carrier 101 and the cavity 103 that is sealed hermetically. The bottom of the cavity 103 is covered by the bottom electrode 102. The same carrier 101 has a reference device 110 having a reference sensor element 114 that is on top of the carrier 101 and the bottom cavity 113 that is sealed hermetically. The bottom of the bottom cavity 113 is covered by the reference bottom electrode 112. Above the reference sensor element 114 there is the top cavity 115 that has approximately the same or larger lateral dimensions and the same location as the bottom cavity 113. The top cavity 115 is hermetically sealed by the top insulator 111 so that the reference sensor element 114 is isolated from the ambient pressure. The purpose of the reference device 110 is to mimic the characteristics of the pressure sensor device 100 in respect to all other characteristics affecting the device apart from the ambient pressure. As the devices are on the same carrier 101 in the vicinity of each other and have similar dimensions, they experience very similar conditions such as ambient temperature, warping of the carrier 101, thermal expansion, noise, vibration etc. For this reason the reference device 110 is suitable for the compensation of the unwanted ambient conditions that may affect the output reading of the pressure sensor device 100. For example in the case of a capacitive sensor the reference device 110 can be used as a reference capacitor whereas the pressure sensor device 100 is used as the pressure sensing capacitor and the difference or ratio between these two capacitance values is used to provide the measured pressure value.

### Typical Characteristics of the Different Embodiments of the Pressure Sensor

Ambient pressure refers to the pressure outside the device boundaries that is being measured by the sensor element of the pressure sensor. This pressure may be caused by a surrounding medium such as gas, liquid or a solid element or object that is touching the sensor element. The pressure measurement can refer also to the characterization of other quantities than the ambient pressure, such as for example acceleration forces of a mass that is causing pressure on the sensor element. All electrodes can be considered to be made of an electrically conductive material and have an electrically conductive interconnection to the periphery of the device, although the interconnections are not shown in the pictures. The size, shape and number of electrodes may be arbitrary for example to provide different measurement ranges and responses as a function of the applied forces. Similarly the lateral shape of the cavity may be arbitrary, such as circular, elliptical, quadratic, rectangular etc. to provide different kind of deformation for the moving membrane part above the cavity. The lateral dimensions of a cavity will typically vary between the micrometer to millimeter range, as an example the cavity may be circular with a diameter of 10 um. The height of the cavity may vary in the range of 1 nm to 1 um, as an example with the previously mentioned lateral dimensions the cavity height may be 20 nm.

The carrier may be for example a substrate material such as glass, gallium arsenide or silicon, or a semiconductor with other integrated circuits such as used in a CMOS chip. The surface layer of the device can be made of a material with low hysteresis and good thermal expansion matching with the surrounding substrate material, such as silicon oxide or silicon nitride in the case of a silicon substrate material. The surface layer thickness can be varied in certain locations above the pressure sensor device cavity or alternatively reinforcing structures can be added in order to provide a desirable deformation of the sensor element as a function of the ambient pressure in various locations where the electrodes are located. The electrodes can be formed by various means compatible to the thin film processing, such as depositing a layer of conductor material, for example aluminum or copper. Another possibility is to increase the conductivity of selected areas of the insulator material by a suitable doping to form the electrodes.

The different electrode layers may use the same or different electrode materials. The electrode material may be a metal or a semiconductor or any other material that provides sufficient conductivity for the operation of the device. The carrier/insulator layers may use the same or different insulator materials. The electrodes, even if referred to as being on top or bottom of an insulator, may be also completely or partially embedded in the insulator. In all mentioned devices the stationary electrode that is used to actuate the structure or acts as the counterpart electrode for the electrodes in the sensor element may consist of several separate electrodes each having a separate control voltage. When a cavity is formed, there may be a conductive or insulating residual layer at the top and/or at the bottom of the cavity, although this is not shown in most of the figures. In the contact forming devices the residual layer will be of a conductive material, whereas in devices where no contact is made between the electrodes, the residual layer may be of conductive or insulating material. There may be no residual layer after the cavity formation. The materials described in conjunction with the devices are simplifications, even though a single material is mentioned there could be several layers of different materials used instead to form e.g. an insulator. A tunneling device can be used in static mode or in mechanical resonance mode. The devices are intended to be connected electrically to other parts of the circuit although interconnections are not shown. None of the devices shown in figures are drawn to scale.

### Actuation and Sensing Mechanisms

The different actuation and sensing mechanisms of the pressure sensor devices are not limited to electrostatic or pressure based forces, but also photonic interaction, thermal expansion, charge induction, acoustic waves, acceleration forces, Van der Waals forces and others may be used.

In a sensor the detection of the measured property in the resonating sensor may be based on changes in one or several of the natural mechanical resonance frequencies of the structure, amplitude of the resonance, changes in the tunneling current(s) of the device, nonlinearity of the device and other known phenomena.

The tunneling current may consist of single electron tunneling, multichannel tunneling or multiflows of tunneling electrons. The oscillating regime, including mechanical resonance, can be created by applying AC voltage to one of the electrodes. To control the device, one can measure the DC component of the current. Change in the pressure can be correlated with the change in the DC component of the current. Alternatively, one can measure the AC current as well and correlate the change in the pressure with change of phase of the AC current. In addition to the measurement of the tunneling current, one can also correlate the change in the pressure with the shift of the resonance frequency.

In a non-resonating structure the detection of the measured property may be based on the capacitance of the device, the tunneling current(s) of the device, the contact resistance of the device and electrical resonance frequency of an electrical resonator containing the device.

### Method of Fabrication

The disclosed embodiments can be realized by using a special procedure to produce vacuum cavities. FIG. 23-FIG. 34 show fabrication steps of a pressure sensor device using conventional CMOS processing. These figures share the same numbering for the same parts of the device, and when the part is modified the different variants have an appended letter (a,b,c) together with the number to identify them. The device is prepared by deposition of thin film layers. The layers are structured using lithography and etching and, finally, the vacuum cavity is formed by diffusion of density changing materials.

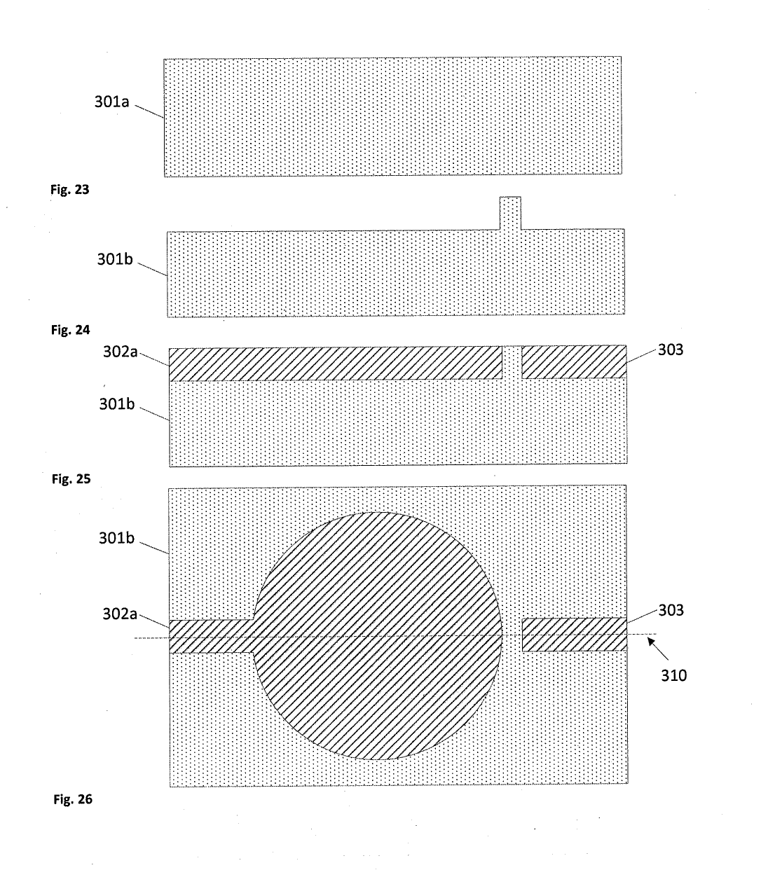

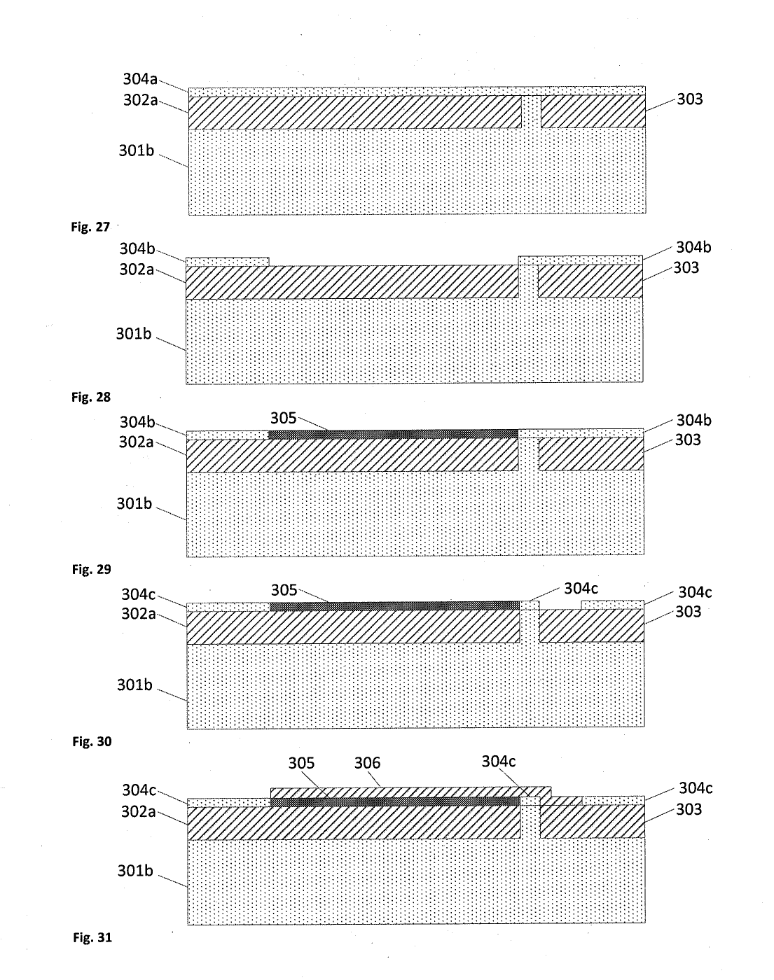

FIG. 23 shows the starting point for the fabrication of the pressure sensor. Fabrication starts from the carrier material 301a, which provides an insulating material base for the device. The entity shown as 301a could be for example a part of a CMOS wafer. The carrier 301a can be patterned by lithography to form the openings in the modified carrier 301b as shown in FIG. 24. Next, the electrode 302a and the interconnection 303 are formed by deposition of metal or another conducting material as shown in FIG. 25.

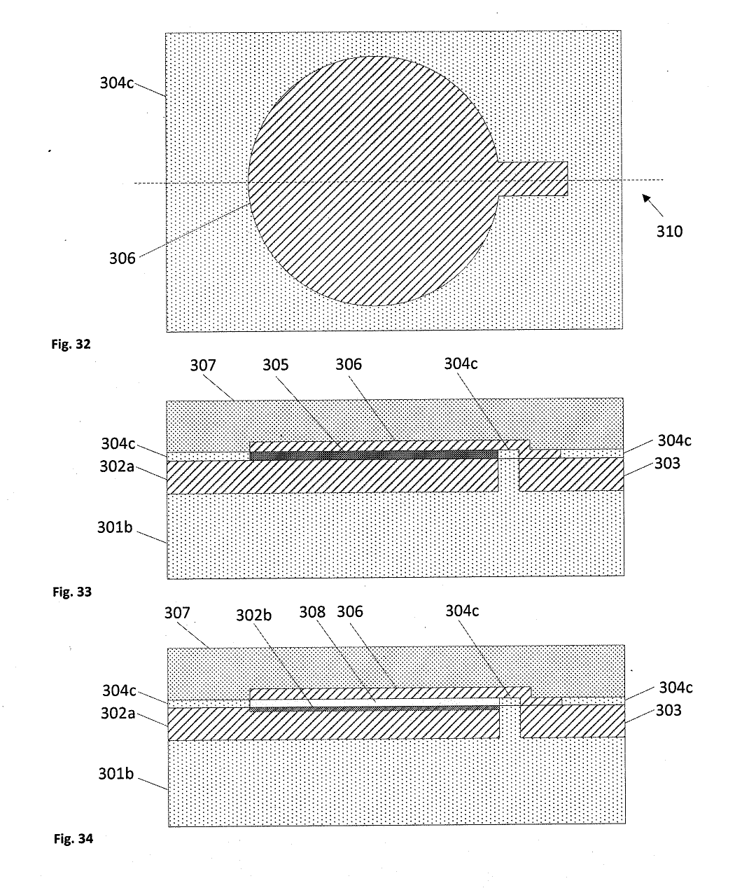

The top view of the same structure is shown in FIG. 26, where the imaginary line 310 shows the plane where the cross-section has been taken for FIG. 25. The following step consists of depositing an insulating layer 304a as shown in FIG. 27. Photolithography is used to define an opening as seen in FIG. 28, so that the insulator layer 304b is formed with an opening. FIG. 29 shows how the opening is filled by depositing the density changing material 305 on top of the electrode 302a. In the next step shown in FIG. 30 an opening is formed by photolithography to provide access to the interconnection 303, resulting in a modification of the insulator layer 304c. The processing continues by depositing a conductive material such as metal or amorphous silicon to form the top electrode 306 that in this particular case covers completely the density changing material 305 and in addition acts as an interconnect to the interconnection 303. This is shown in FIG. 31 and FIG. 32 that represent the cross-section and top view respectively, where the cross-section has been taken along the imaginary line 310.

Finally as shown in FIG. 33 the top insulator layer 307 is deposited to form a layer that acts as the sensor element above the area defined by the density changing material 305, and provides hermetic sealing of the structure. After all structures on the carrier/wafer have been finalized, a special treatment is made so that the density changing material shrinks releasing the vacuum cavity 308. The density changing material interacts with the electrode 302a so that the residual layer 302b is formed. The materials for the density changing material 305 and the electrode 302a can be selected so that the residual layer 302b is either insulating or conducting based on the need. FIG. 34 shows the final device.

The fabrication of the transition layer including vacuum cavity is based on the use of a density changing material. The material is prepared along with the other structures of the devices. After the device is fabricated, the density changing material shrinks in special conditions releasing the vacuum cavity. Shrinking of the density changing material layer is a result of increase of density. This can be calculated using number of atoms participating in diffusion process and chemical reaction. Particularly, as an example, the following metals and oxides, can compose the density changing material and the microelectromechanical device described above;

Cu and its oxide as a base material for density changing material

Insulator material SiO₂

Electrode material Al, Cu, Ti, W, Mo, a-Si

Top electrode material

There are possible variations of the devices disclosed in this patent application as well as other designs based on use of one or more vacuum cavities with variations of insulator materials. Such variations are covered by this specification.

While the foregoing written description of the inventions enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A MEMS pressure sensor device, comprising:
a sensor element positioned on top of a carrier and
a cavity, wherein the sensor element hermetically seals the cavity,
an electrode coupled to the cavity that forms a pressure transducer together with the sensor element, wherein the cavity is created by a density changing material.
